(19) United States
(12) Patent Application Publication
(10) Pub. No.: US 2010/0188946 A1
(43) Pub. Date: Jul. 29, 2010

(54) HEAD TESTING METHOD AND HEAD TESTING DEVICE

(75) Inventor: Takeshi OHWE, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/754,482

(22) Filed: Apr. 5, 2010

Related U.S. Application Data
(63) Continuation of application No. PCT/JP2007/069631, filed on Oct. 5, 2007.

(51) Int. Cl. G11B 20/18

(52) U.S. Cl. 369/53.1; G9B/20.046

(57) ABSTRACT

According to one embodiment, a head testing method, includes: positioning a protrusion against a flexure at a backside of a head slider fixed onto the flexure so that the protrusion receives the head slider from behind the head slider; positioning the head slider on a surface of a rotating magnetic disk so that the head slider faces a surface of the rotating magnetic disk, and reading magnetic information from the magnetic disk by an electromagnetic conversion element of the head slider; and outputting the magnetic information read by the electromagnetic conversion element through the wiring pattern.

### CROSS-REFERENCE TO RELATED APPLICATIONS

This application is a continuation of PCT international application Ser. No. PCT/JP2007/069631 filed on Oct. 5, 2007 which designates the United States, incorporated herein by reference.

### BACKGROUND

1. Field

One embodiment of the invention relates to a head testing method and a head testing device for testing properties of an electromagnetic conversion element embedded in a head slider.

2. Description of the Related Art

A so-called head suspension assembly is prepared in a property test of the electromagnetic conversion element embedded in the head slider. The head suspension assembly is provided with a head suspension. A flexure is joined onto the head suspension. A head slider is fixed onto the flexure. A wiring pattern, which extends on the flexure, is connected to the head slider. In other words, the head suspension assembly is prepared in a state of being attached to an end of a carriage arm. Such head suspension assembly is supported by a predetermined supporting member. Magnetic information is written into a rotating magnetic disk by the electromagnetic conversion element. The written magnetic information is read out. In this manner, the properties of the electromagnetic conversion element are tested.

On the other hand, as disclosed in International Publication No. 03/012781, the head testing device for testing the properties of the electromagnetic conversion element is known. In the head testing device, a head slider is positioned to face a surface of the magnetic disk. The head slider is supported alone by a supporting stage so as to be able to change its attitude. A wiring pattern is connected to a conductive pad formed on an end surface of the head slider based on a contact point. The conductive pad is connected to the electromagnetic conversion element. As in the above-described case, the magnetic information is written into the rotating magnetic disk by the electromagnetic conversion element. The written magnetic information is read by the electromagnetic conversion element. In this manner, the properties of the electromagnetic conversion element are tested.

When the property test is performed with respect to the head suspension assembly, the electromagnetic conversion element, which does not satisfy a predetermined criterion, is detected, for example. Since the head slider is firmly bonded onto the flexure, the head slider cannot be detached from the flexure. If the head slider is forcedly detached from the flexure, the flexure might be deformed. As a result, the head suspension assembly provided with the electromagnetic conversion element, which does not satisfy the criterion, is discarded together with the head suspension assembly. In this case, not only the head slider but also the flexure and the head suspension are wasted. This causes significant loss in cost.

On the other hand, International Publication No. 03/012781 discloses the head testing device on which the head slider alone is mounted. In this head testing device, when the head slider is attached, only the contact point contacts the conductive pad of the head slider. Therefore, sufficient connection is not established between the conductive pad and the contact point. When writing and reading the magnetic information, the head slider changes its attitude in accordance with a swell of the surface of the magnetic disk, for example. As a result, it is difficult to inhibit occurrence of contact resistance between the conductive pad and the contact point when the head slider changes its attitude. Such contact resistance causes loss in output of the magnetic information read by the electromagnetic conversion element. Furthermore, it is very difficult to flexibly support the change in attitude of the head slider.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plane view of a hard disk driving device (HDD) according to an embodiment of the invention;

FIG. 2 is an exemplary perspective view of a head suspension assembly in the embodiment;

FIG. 3 is an exemplary perspective view of a head testing device according to a first embodiment of the invention;

FIG. 4 is an exemplary enlarged perspective view of a base in the first embodiment;

FIG. 5 is an exemplary cross-sectional view of the base in the first embodiment;

FIG. 6 is an exemplary block diagram of a control system of the head testing device in the first embodiment;

FIG. 7 is an exemplary perspective view of a flexure module that is fixed onto the base, in the first embodiment;

FIG. 8 is an exemplary side view illustrating a state in which a base is moved toward a magnetic disk in the first embodiment;

FIG. 9 is an exemplary side view illustrating a state in which the head slider is positioned to face a surface of the magnetic disk in the first embodiment;

FIG. 10 is another exemplary side view illustrating the state in which the head slider is positioned to face the surface of the magnetic disk in the first embodiment;

FIG. 11 is an exemplary cross-sectional view of the base according to a modification of the first embodiment;

FIG. 12 is an exemplary perspective view of a head testing device according to a second embodiment of the invention;

FIG. 13 is an exemplary enlarged perspective view of a base in the second embodiment;

FIG. 14 is an exemplary perspective view of a flexure module that is fixed onto the base, in the second embodiment;

FIG. 15 is an exemplary side view illustrating a state in which the base is moved toward the magnetic disk in the second embodiment; and

FIG. 16 is an exemplary side view illustrating a state in which the head slider is positioned to face a surface of the magnetic disk in the second embodiment.

### DETAILED DESCRIPTION

Various embodiments according to the invention will be described hereinafter with reference to the accompanying drawings. In general, according to one embodiment of the invention, a head testing method, comprises: positioning a protrusion against a flexure at a backside of a head slider fixed onto the flexure so that the protrusion receives the head slider from behind the head slider; positioning the head slider on a surface of a rotating magnetic disk so that the head slider faces a surface of the rotating magnetic disk, and reading magnetic information from the magnetic disk by an electromagnetic conversion element of the head slider; and outputting the magnetic information read by the electromagnetic conversion element through the wiring pattern.

According to another embodiment of the invention, ahead testing device, comprises: a protrusion receiving a flexure at a backside of a head slider having an electromagnetic conversion element; a base, the flexure being detachably fixed on a surface of the base; a magnetic disk facing the surface of the base; a rotational driving mechanism configured to drive and rotate the magnetic disk; and a control circuit formed on a surface of the flexure and configured to extract magnetic information through a wiring pattern connected to the electromagnetic conversion element by a conductive body.

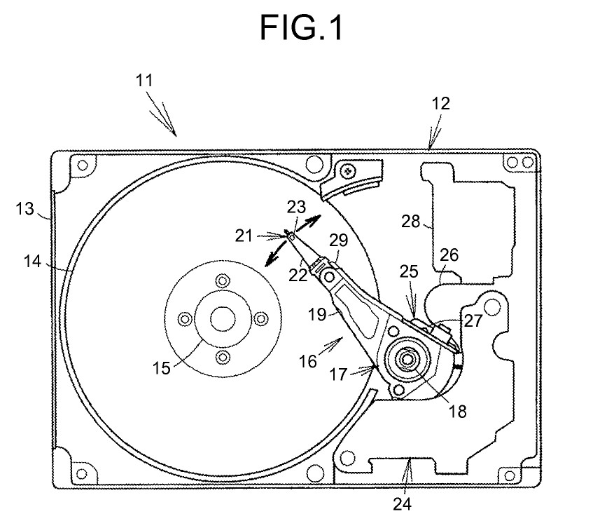

FIG. 1 schematically illustrates an internal structure of a hard disk driving device (HDD) 11 as one example of a storage medium driving device. The HDD 11 is provided with a casing, or equivalently, a housing 12. The housing 12 is composed of a box-shaped base 13 and a cover (not illustrated). The base 13 defines a flat rectangular parallelepiped-shaped internal space, for example, or equivalently, a storage space. The base 13 may be formed by casting of a metal material such as Aluminum. The cover is connected to an opening of the base 13. The storage space between the cover and the base 13 is hermetically sealed. The cover maybe formed of one plate material by press working, for example.

In the storage space, at least one magnetic disk 14 is stored as a storage medium. The magnetic disk 14 is mounted on a rotating shaft of a spindle motor 15. The spindle motor 15 may rotate the magnetic disk 14 at high speed such as, 5,400 rpm, 7,200 rpm, 10,000 rpm and 15,000 rpm.

In the storage space, a carriage 16 is further stored. The carriage 16 is provided with a carriage block 17. The carriage block 17 is rotatably coupled to a support shaft 18, which extends perpendicularly. A plurality of carriage arms 19, which extend horizontally from the support shaft 18, are defined in the carriage block 17. The carriage block 17 maybe formed of Aluminum by extrusion, for example.

A head suspension assembly 21 is attached to an end of each of the carriage arms 19. This may be attached by caulking, for example. At the time of caulking, a hole defined on the end of the carriage arm 19 and a hole defined on a back end of the head suspension assembly 21 may be aligned. The head suspension assembly 21 is provided with a head suspension 22. The head suspension 22 extends forward from the end of the carriage arm 19. A flying head slider 23 is supported at a front end of the head suspension 22. A head, or equivalently, an electromagnetic conversion element, is mounted on the flying head slider 23.

When airflow is generated on a surface of the magnetic disk 14 based on rotation of the magnetic disk 14, positive pressure, or equivalently, buoyant force and negative pressure act on the flying head slider 23 by action of the airflow. When the buoyant force and the negative pressure are in balance with pressing force of the head suspension 22, the flying head slider 23 may keep flying with relatively high rigidity during the rotation of the magnetic disk 14.

When the carriage 16 rotates around the support shaft 18 while the flying head slider 23 is thus flying, the flying head slider 23 may move along a radial line of the magnetic disk 14. As a result, the electromagnetic conversion element on the flying head slider 23 may traverse a data zone between an innermost recording track and an outermost recording track. In this manner, the electromagnetic conversion element on the flying head slider 23 is positioned on a target recording track.

A power source such as a voice coil motor (VCM) 24 is connected to the carriage block 17. The carriage block 17 may rotate around the support shaft 18 by action of the VCM 24. Swing of the carriage arm 19 and the head suspension 22 is realized based on such rotation of the carriage block 17.

As is clear from FIG. 1, a flexible printed circuit board module 25 is arranged on a main body of the carriage block 17. The flexible printed circuit board module 25 is provided with a head integrated circuit (IC) 27 mounted on a flexible printed circuit board 26. When reading magnetic information, sense current is supplied from the head IC 27 toward a read head element of the electromagnetic conversion element. A current-perpendicular-to-plane (CPP) structure read element is used, for example, as the read head element. Similarly, when writing the magnetic information, writing current is supplied from the head IC 27 toward a write head element of the electromagnetic conversion element. A thin-film magnetic head element is used, for example, as the write head element.

The sense current and the writing current are supplied from a small circuit board 28 arranged in the storage space and a printed circuit board (not illustrate) attached to a rear side of a bottom plate of the base 13 to the head IC 27. When supplying such sense current and writing current, a flexible printed circuit board 29 is used. The flexible printed circuit board 29 is connected to the flexible printed circuit board module 25.

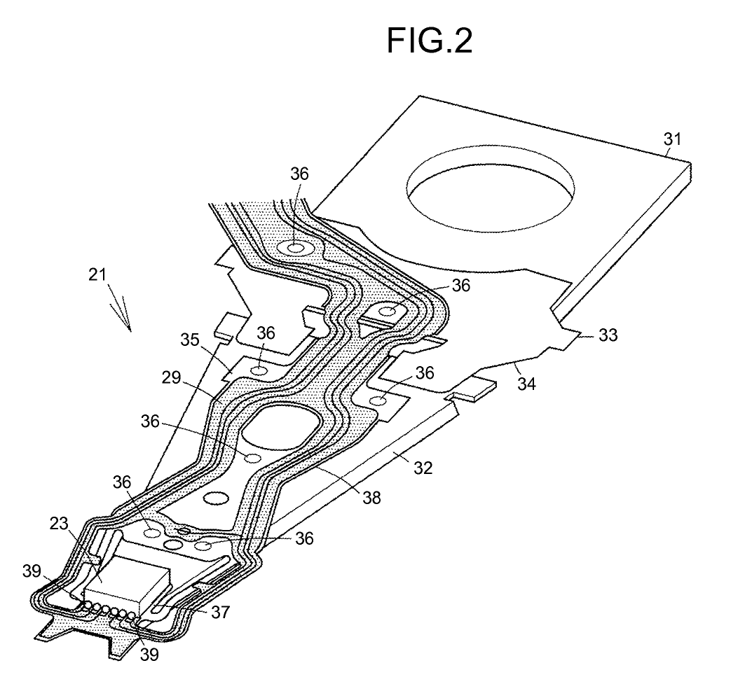

FIG. 2 schematically illustrates a structure of the head suspension assembly 21. The head suspension assembly 21 is provided with a base plate 31 attached to the end of the carriage arm 19 and a load beam 32 separated forward from the base plate 31 at a predetermined interval. The base plate 31 is fixed to the carriage arm 19 by caulking, for example. A hinge plate 33 is fixed to surfaces of the base plate 31 and the load beam 32. The hinge plate 33 defines an elastic deformation portion 34 between a front end of the base plate 31 and a back end of the load beam 32. In this manner, the hinge plate 33 couples the base plate 31 to the load beam 32. The base plate 31, the load beam 32 and the hinge plate 33 compose the head suspension 22.

A flexure 35 is partially fixed to a surface of the head suspension 22. At the time of fixing, spot welding may be performed at a plurality of junction spots 36, for example. A YAG laser may be used in the spot welding, for example. The above-described flexible printed circuit board 29 is formed on a surface of the flexure 35. The flexible printed circuit board 29 comprises a wiring pattern. The flexure 35 extends backward from a base end of the head suspension 22. Aback end of the flexure 35 extends to the flexible printed circuit board module 25. That is to say, the head suspension module 21 composes a so-called long-tail type. The flexible printed circuit board 29 may be provided with an insulating layer, a conductive layer and a protective layer stacked on the flexure 35 in this order, for example. A conductive material such as Copper may be used as the conductive layer. A resin material such as a Polyimide resin may be used as the insulating layer and the protective layer.

The flexure 35 defines a support plate 37, which receives the flying head slider 23 on a surface thereof, and a fixed plate 38 fixed on surfaces of the load beam 32 and the hinge plate 33. The flying head slider 23 may be bonded to a surface of the support plate 37. The flying head slider 23 and the flexible printed circuit board 29 are electrically connected to each other by a conductive body 39. The conductive body 39 is received by a conductive pad defined on an air outflow side end surface of the flying head slider 23. The conductive pad is connected to the electromagnetic conversion element. Similarly, the conductive body 39 is received by the conductive pad defined on the flexible printed circuit board 29. The flexure 35, the flying head slider 23, the flexible printed circuit board 29 and the conductive body 39 compose a flexure module of the embodiment.

Behind the flying head slider 23, the support plate 37 is received by a dome-shaped protrusion (not illustrated) formed on a surface of the load beam 32. The above-described elastic deformation portion 34 exerts predetermined elastic force, or equivalently, bending force. Pressing force against the surface of the magnetic disk 14 is provided on a front end of the load beam 32 by the bending force. The pressing force acts on the flying head slider 23 from behind the support plate 37 by action of the protrusion. The flying head slider 23 may change an attitude thereof based on the buoyant force generated by the action of the airflow. The protrusion allows the flying head slider 23, that is to say, the support plate 37 to change the attitude thereof.

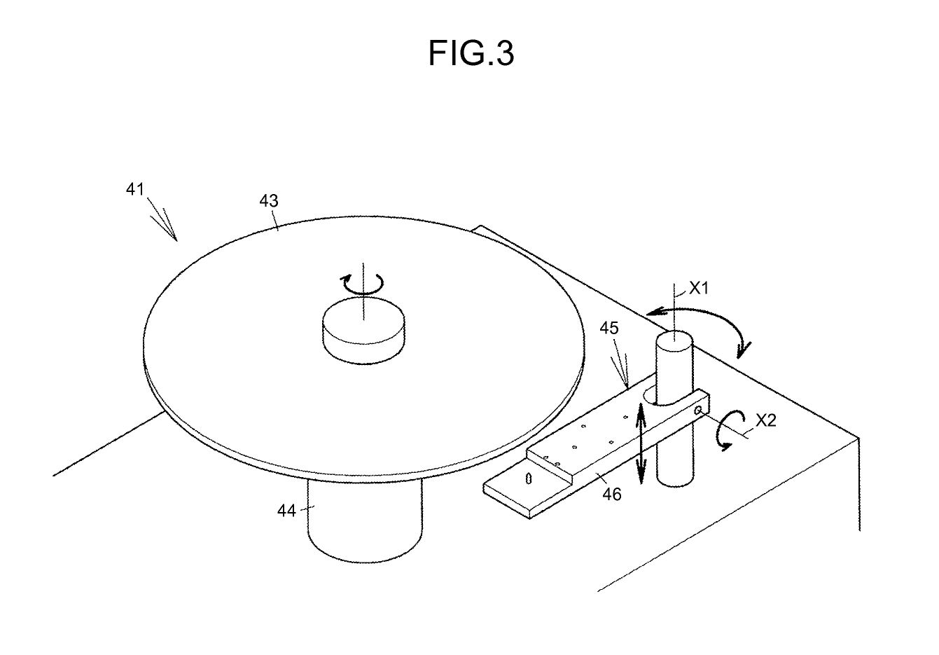

FIG. 3 schematically illustrates a structure of a head testing device 41 according to a first embodiment of the invention. The head testing device 41 is provided with a magnetic disk 43, which rotates around a rotational axis. The magnetic disk 43 may be rotationally driven by a rotational driving mechanism, or equivalently, a spindle motor 44. A supporting mechanism 45 is associated with the magnetic disk 43. The supporting mechanism 45 is provided with a base 46. The base 46 may realize up-and-down movement in a perpendicular direction along a perpendicular axis X1 and rotational movement around the perpendicular axis X1. At the same time, the base 46 may swing around a horizontal axis X2. The horizontal axis X2 is provided so as to be parallel to a surface of the magnetic disk 43.

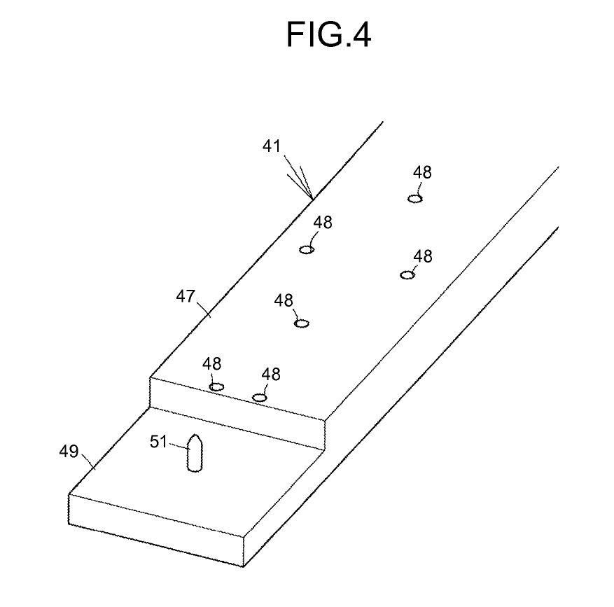

As illustrated in FIG. 4, a plurality of intake openings 48 are formed on a surface 47 of the base 46. A stepped surface 49 lower than the surface 47 by a step is provided on the base 46. A push pin 51 is embedded in the stepped surface 49. With reference to FIG. 5 also, an intake path 52, which extends inside the base 46, is connected to the intake openings 48. The intake path 52 is connected to a vacuum pump 53. The vacuum pump 53 may suck air from the intake path 52. A proximal end of the push pin 51 is received by an elastic member such as a coil spring 54. In this manner, the pushpin 51 is embedded in the base 46 so as to be relatively movable along an axis thereof.

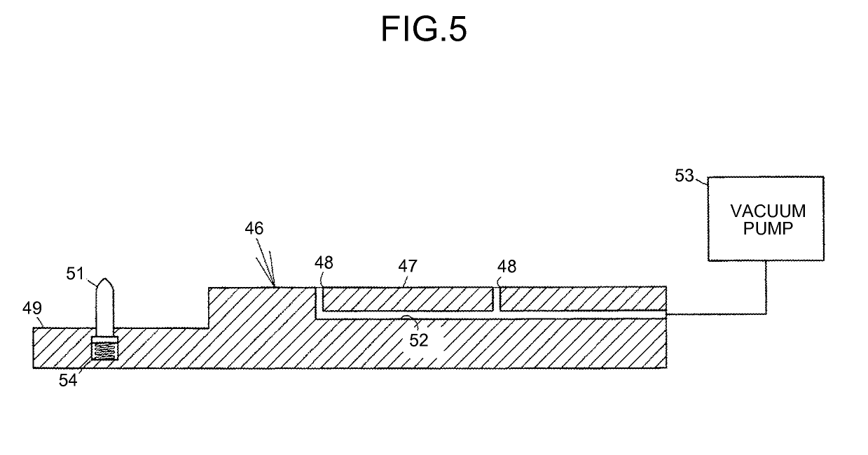

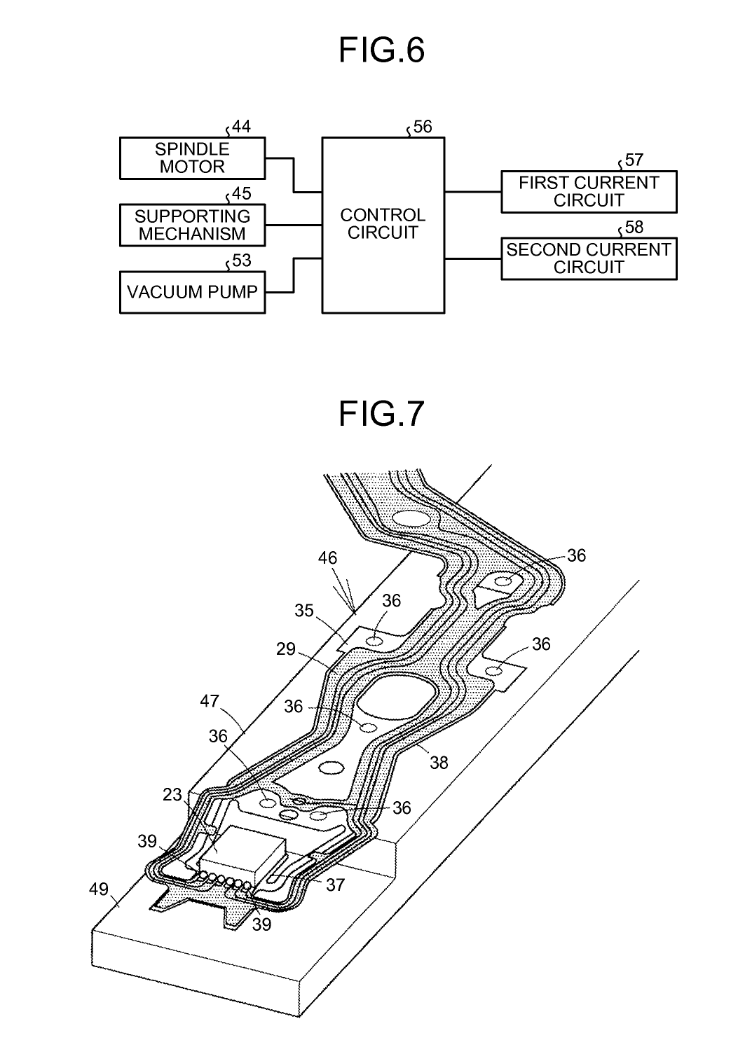

As illustrated in FIG. 6, the head testing device 41 is provided with a control circuit 56. A first current supply circuit 57, which supplies the sense current to the read head element of the flying head slider 23, and a second current supply circuit 58, which supplies the writing current to the write head element, are embedded in the control circuit 56. The first current supply circuit 57 and the second current supply circuit 58 may be composed as the above-described head IC 27. The above-described spindle motor 44, the supporting mechanism 45 and the vacuum pump 53 are connected to the control circuit 56. Driving of the spindle motor 44, the supporting mechanism 45 and the vacuum pump 53 is controlled by a control signal output from the control circuit 56.

Next, a head testing method performed by the head testing device 41 is simply described. First, as illustrated in FIG. 7, a finished flexure module capable of being attached to the head suspension 22 is prepared. The flying head slider 23 fixed onto the flexure 35 is electrically connected to the flexible printed circuit board 29 by the conductive body 39. The flexure 35 is received by the surface 47 of the base 46 via the fixed plate 38. The head suspension 22 is not interposed between the flexure 35 and the surface 47 of the base 46. The intake openings 48 are allowed to face presumptive areas of spot welding, or equivalently, the junction spots 36. When the vacuum pump 53 is driven, the vacuum pump 53 sucks air from the intake path 52. The fixed plate 38 sticks to the intake openings 48. As a result, the flexure 35, that is to say, the flexure module is fixed to the surface 47 of the base 46 at the junction spots 36.

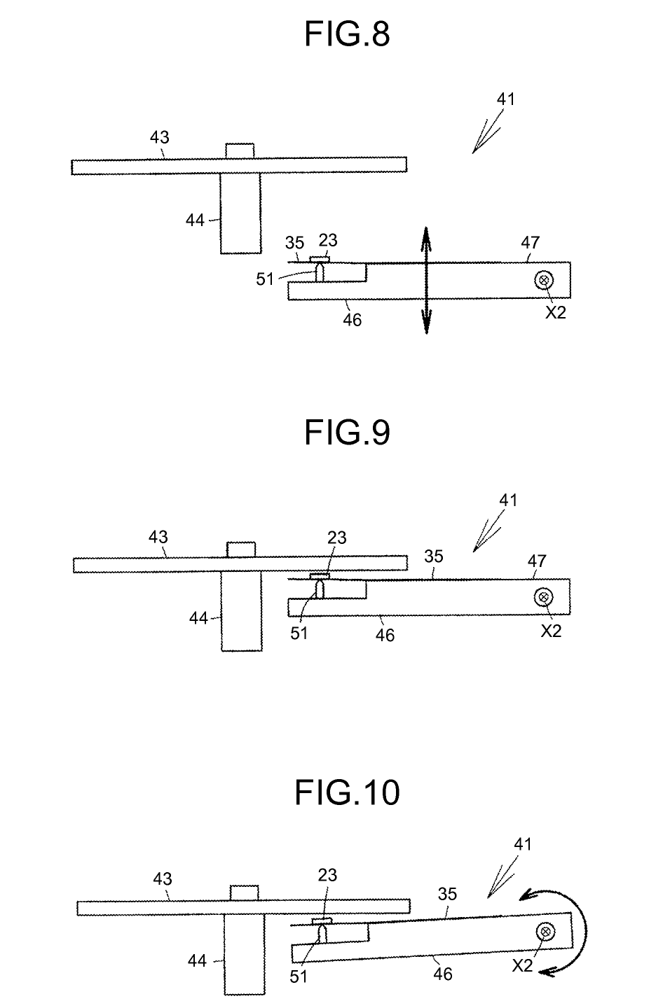

The flexible printed circuit board 29 on the flexure 35 is connected to the first current supply circuit 57 and the second current supply circuit 58. When the magnetic disk 43 rotates around the rotational axis, as illustrated in FIG. 8, the base 46 moves along the perpendicular axis X1 by action of the supporting mechanism 45. In this manner, as illustrated in FIG. 9, the base 46 is arranged at a predetermined distance from a rear surface of the magnetic disk 43. The surface 47 of the base 46 may establish a horizontal attitude parallel to a horizontal plane, for example. An end of the push pin 51 is positioned against the support plate 37 from behind the flying head slider 23. The flying head slider 23 is pressed against the rear surface of the magnetic disk 43 with predetermined pressing force. The flying head slider 23 is kept floated from the rear surface of the magnetic disk 43 at a predetermined flying height. In this manner, loading of the flying head slider 23 from the rear surface of the magnetic disk 43 is performed. At that time, the push pin 51 is elastically movable along the axis thereof by action of the coil spring 54. The pressing force is adjusted constant based on such elastic movement of the push pin 51.

The flying head slider 23 is positioned on a predetermined recording track on the magnetic disk 43 based on rotation of the base 46 around the perpendicular axis X1. For example, the flying head slider 23 is positioned on an outer peripheral side of the magnetic disk 43. The first current supply circuit 57 supplies the sense current to the read head element of the electromagnetic conversion element at the time of reading. The supporting mechanism 45 swings the base 46 around the perpendicular axis X1 based on an output of the read head element. As a result, the read head element of the flying head slider 23 follows a predetermined recording track. At that time, the write head element of the electromagnetic conversion element writes the magnetic information into the recording track. At the time of writing, the current is supplied to the write head element from the second current supply circuit 58.

After the writing of the magnetic information, the read head element of the flying head slider 23 reads the written magnetic information. The read magnetic information is output from the flexible printed circuit board 29 to the control circuit 56. The output magnetic information is analyzed by the control circuit 56.

In this manner, properties of the electromagnetic conversion element are tested on the recording track on the outer peripheral side of the magnetic disk 43. Thereafter, the base 46 swings around the perpendicular axis X1 by the action of the supporting mechanism 45. The flying head slider 23 is positioned on an inner peripheral side of the magnetic disk 43. A property test of the electromagnetic conversion element is performed on the recording track on the inner peripheral side. Similarly, the property test of the electromagnetic conversion element is performed on the recording track provided between the outer peripheral side and the inner peripheral side. However, the magnetic information may be only written and read on the outer peripheral side.

When the property test is finished, the base 46 moves along the perpendicular axis X1 by the action of the supporting mechanism 45. The base 46 is separated from the rear surface of the magnetic disk 43. In this manner, unloading of the flying head slider 23 from the rear surface of the magnetic disk 43 is performed. When the base 46 is sufficiently separated from the rear surface of the magnetic disk 43, the base 46 stops moving. The vacuum pump 53 stops driving. As a result, the flexure 35 is easily detached from the surface 47 of the base 46. When writing and reading of the magnetic information satisfy a predetermined criterion, the flying head slider 23, that is to say, the flexure module passes the property test. The flexure module, which passed the property test, is attached to the head suspension 22. The head suspension 22 is attached to the end of the carriage arm 19. In this manner, the carriage 16 is fabricated. On the other hand, when a defective flexure module, which does not satisfy the predetermined criterion, is detected, the flexure module is discarded.

In the above-described head testing device 41, the flexure module is detachably fixed to the base 46. The flying head slider 23, the flexible printed circuit board 29 and the conductive body 39 are assembled with respect to the flexure 35 in advance. The flexible printed circuit board 29 is used when writing and reading the magnetic information. The flying head slider 23 and the flexible printed circuit board 29 are connected by the conductive body 39. Occurrence of contact resistance is avoided. The property test of the electromagnetic conversion element is stably performed. Furthermore, since the flexure module is discarded, a waste generation is significantly reduced as compared to a case in which the head suspension assembly 21 itself is discarded, for example. Loss in cost is avoided as far as possible.

As illustrated in FIG. 10, when the flying head slider 23 is positioned to face the surface of the magnetic disk 43, the base 46 may swing around the horizontal axis X2. In this manner, the base 46 may be arranged at a predetermined distance from the rear surface of the magnetic disk 43. At that time, the up-down movement in the perpendicular direction along the perpendicular axis X1 may be combined. The horizontal axis X2 may be arranged so as to be closer to an end of the base 46. When fixing the flexure 35, an adhesive capable of easily attaching and detaching the flexure 35 may be used in place of the intake openings 48, the intake path 52 and the vacuum pump 53.

In the head testing device 41 as described above, when a position in the perpendicular direction along the perpendicular axis X1 is adjusted in advance before loading and unloading the flying head slider 23, the loading and unloading may be performed only by the rotational movement around the perpendicular axis X1 and the swing around the horizontal axis X2. Similarly, in the head testing device 41, when a position around the horizontal axis X2 is adjusted in advance before loading and unloading the flying head slider 23, the loading and unloading may be performed only by the up-and-down movement along the perpendicular axis X1 and the rotational movement around the perpendicular axis X1.

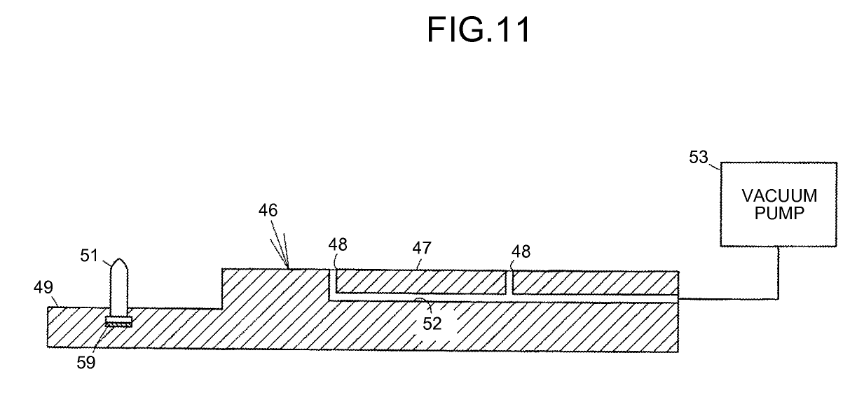

As illustrated in FIG. 11, a load sensor 59 may be embedded in place of the coil spring 54 in the proximal end of the push pin 51. The load sensor 59 may detect load acting on the push pin 51 from the flying head slider 22, that is to say, the support plate 37. A piezoelectric film of polyvinylidene fluoride (PVDF) may be used, for example, as the load sensor 59. The piezoelectric film is set so as to be not thicker than 100 μm, for example. Thin plates made of rubber may be superposed on a surface and a rear surface of the piezoelectric film, for example.

In such load sensor 59, distortion, or equivalently, change in thickness occurs in the piezoelectric film according the load. Voltage is generated in the piezoelectric film based on the distortion. The voltage is taken out from wiring connected to the piezoelectric film. The load is detected based on such voltage. Based on the detected load, the control circuit 56 controls the load based on the up-and-down movement of the base 46 in the perpendicular direction along the perpendicular axis X1 and the swing of the base 46 around the horizontal axis X2. As a result, the pressing force of the flying head slider 23 may be controlled to be constant.

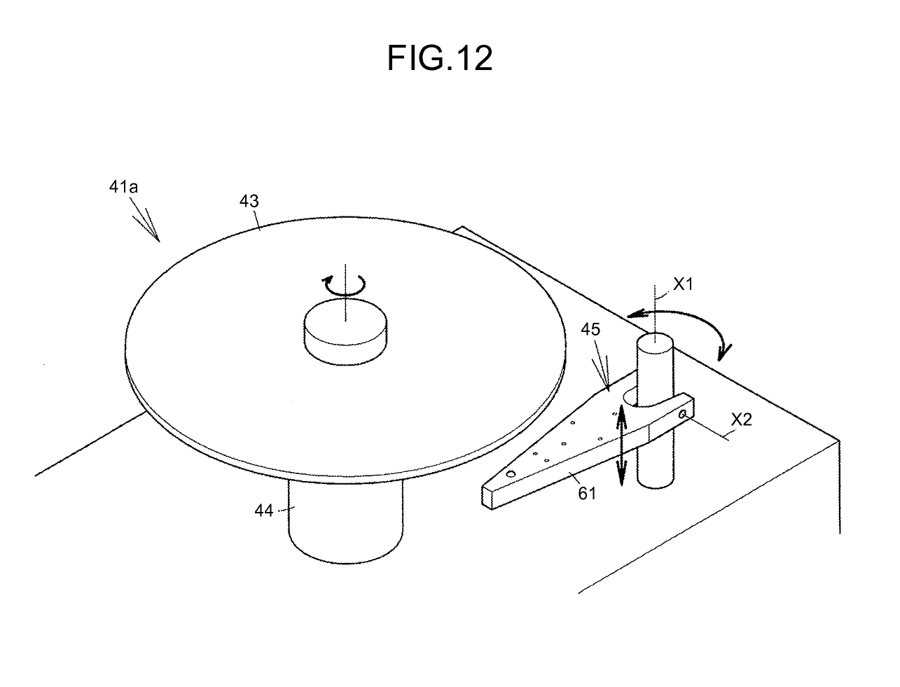

FIG. 12 schematically illustrates a structure of a head testing device 41a according to a second embodiment of the invention. A base 61 is embedded in the head testing device 41a in place of the above-described base 46. The base 61 may realize the up-and-down movement in the perpendicular direction along the perpendicular axis X1 and the rotational movement around the perpendicular axis X1 as in the above-described base 46. On the other hand, a coil spring (not illustrated) is coupled to the base 61, for example. The base 61 may be elastically movable from a reference position within a predetermined area around the horizontal axis X2 by action of the coil spring. At the reference position, a surface of the base 61 is provided along the horizontal plane, for example.

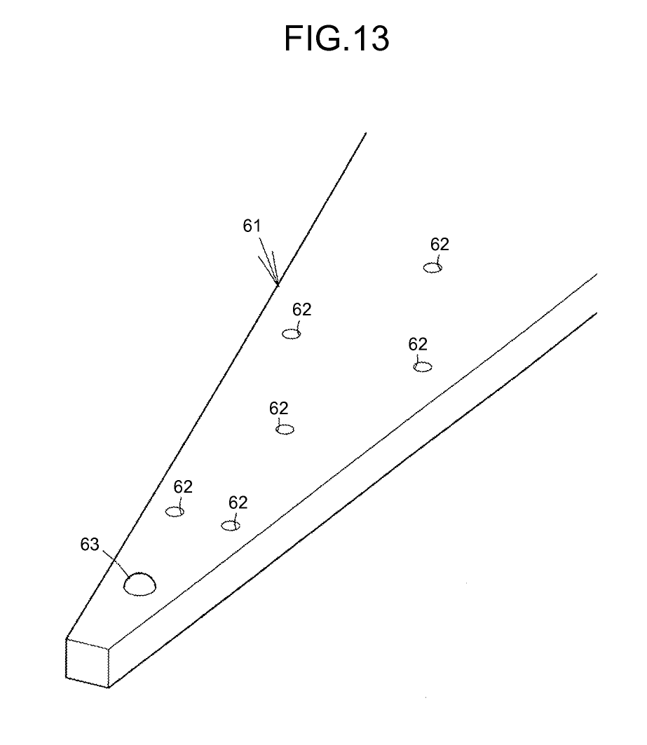

As illustrated in FIG. 13, intake openings 62 are formed on the surface of the base 61. As in the above-described case, the intake openings 62 are formed so as to correspond to the positions of the junction spots 36 of the flexure 35. The intake path, which extends inside the base 61, is connected to the intake openings 62. The vacuum pump is connected to the intake path. The intake path and the vacuum pump may be composed as that of the base 46. A dome-shaped protrusion 63 is formed on the surface of the base 61. The protrusion 63 is composed as similar to the protrusion formed on the head suspension 22. The same reference numeral is given to the configuration and the structure equivalent to those described above.

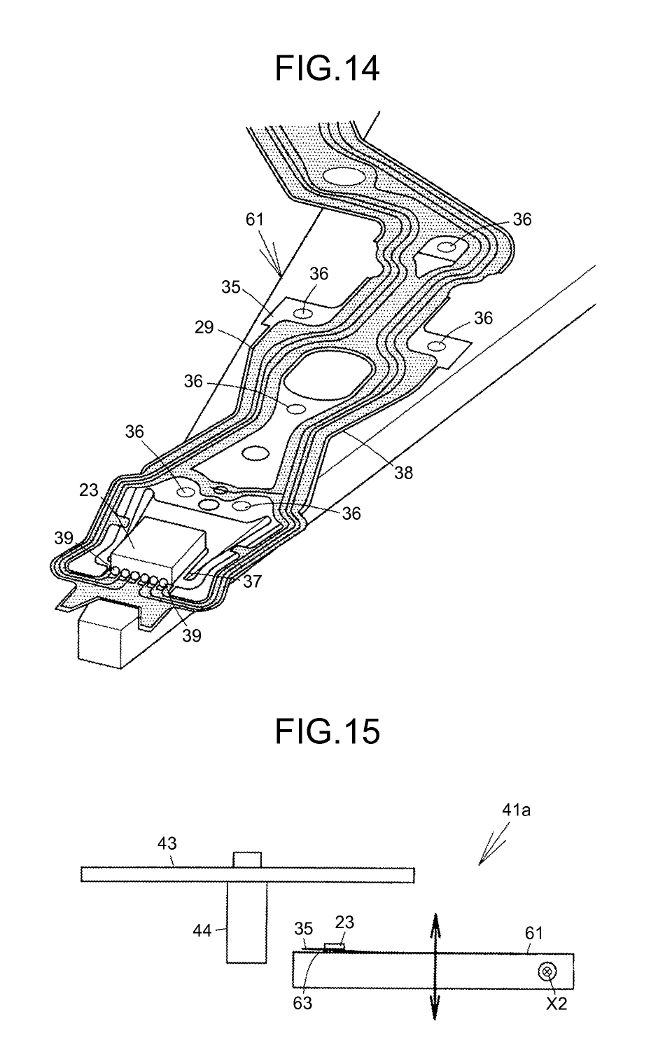

Next, the head testing method performed by the head testing device 41a is simply described. As illustrated in FIG. 14, the finished flexure module capable of being attached to the head suspension 22 is fixed to the surface of the base 61. The head suspension 22 is not interposed between the surfaces of the flexure 35 and the base 61. The flexure 35 is received by the surface of the base 61 via the fixed plate 38. The intake openings 62 are allowed to face the junction spots 36. The fixed plate 38 sticks to the intake openings 62 by the driving of the vacuum pump. As a result, the flexure 35 is fixed to the surface of the base 61. The protrusion 63 is positioned against the support plate 37 from behind the flying head slider 23.

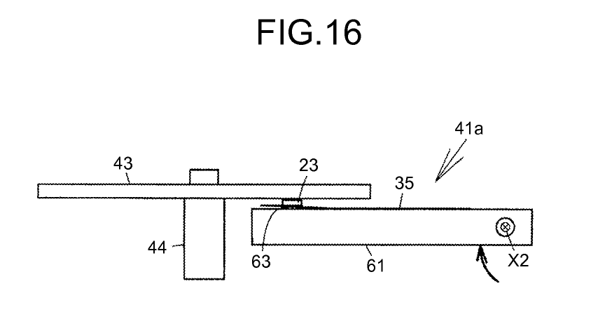

As illustrated in FIG. 15, the base 61 moves along the perpendicular axis X1 by the action of the supporting mechanism 45. As a result, as illustrated in FIG. 16, the flying head slider 23 is positioned to face the rear surface of the magnetic disk 43. The flying head slider 23 is pressed against the rear surface of the magnetic disk 43 by predetermined pressing force by action of the protrusion 63. The flying head slider 23 is kept floated from the rear surface of the magnetic disk 43 at a predetermined flying height. The base 61 is elastically movable around the horizontal axis X2 by action of spring force of the coil spring. As a result, the pressing force is adjusted constant. As in the above-described case, writing and reading of the magnetic information are performed by the electromagnetic conversion element. The test of the properties of the electromagnetic conversion element is performed.

In the head testing device 41a as described above, like the above-described head testing device 41, the flexure 35 is fixed to the base 61. The flying head slider 23, the flexible printed circuit board 29 and the conductive body 39 are assembled in advance with respect to the flexure 35. When writing and reading the magnetic information, the flexible printed circuit board 29 is utilized. The flying head slider 23 and the flexible printed circuit board 29 are connected to each other by the conductive body 39. The occurrence of the contact resistance is avoided. The property test of the electromagnetic conversion element is stably performed. Furthermore, since the flexure module is discarded, the waste generation is significantly reduced as compared to a case in which the head suspension assembly 21 itself is discarded. The loss in cost is avoided as far as possible.

According to any one of the embodiments, the flexure module can be tested as if it was mounted on the head suspension and tested. When the defective head slider is detected, only the flexure, the head slider, and the wiring pattern are discarded. Hence, comparing to the case when the entire head suspension assembly is discarded, the generation of the waste can be suppressed.

Further, according to any one of the embodiments, the attitude of the head slider can be changed in accordance with the airflow generated based on the rotation of the magnetic disk. The head slider can continuously and steadily fly over the surface of the magnetic disk.

Further, according to any one of the embodiments, the property test of the head can be performed under preferable condition.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head testing method, comprising:
positioning a protrusion against a flexure at a backside of a head slider attached onto the flexure so as to allow the protrusion to receive the head slider from behind the head slider;
positioning the head slider on a surface of a rotating magnetic disk so as to allow the head slider to face a surface of the rotating magnetic disk, and reading magnetic information from the magnetic disk by an electromagnetic convertor of the head slider; and
outputting the magnetic information read by the electromagnetic convertor through the wiring pattern.

2. The head testing method of claim 1, further comprising adjusting a flying height of the head slider based on elastic movement of the protrusion while reading.

3. The head testing method of claim 1, further comprising, for the reading, adjusting a flying height of the head slider based on elastic movement of the base.

4. The head testing method of claim 1, wherein the flexure is attached to the surface of the base on an area configured to receive spot welding.

5. A head testing device, comprising:
a protrusion receiving a flexure at a backside of ahead slider comprising an electromagnetic convertor;
a base, configured to be detachably attached to the flexure on a surface of the base;
a magnetic disk facing the surface of the base;
a rotational driver configured to drive and rotate the magnetic disk; and
a controller on a surface of the flexure and configured to extract magnetic information through a wiring pattern connected to the electromagnetic convertor via a conductor.

6. The head testing device of claim 5, further comprising a spring receiving the protrusion so as to allow the protrusion to elastically move.

7. The head testing device of claim 5, further comprising a supporting portion configured to support the base so as to allow the base to elastically move.

8. The head testing device of claim 5, further comprising:
an inlet on the surface of the base and facing an area configured to receive spot welding on the flexure;
an intake path connected to the inlet and extending inside the base; and
a vacuum pump connected to the intake path.
